(19) United States
(12) Patent Application Publication
(10) Pub. No.: US 2004/0217269 A1
(43) Pub. Date: Nov. 4, 2004

(54) Optoelectronic angle-of-rotation sensor

(75) Inventors: Andreas Kall, Riolasingen (DE); Harald Koehnlein, Radolfzell (DE); Wolfgang Bruetsch, Bodman-Ludwigshafen (DE); Ulf Mordau, Deisslingen (DE)

Correspondence Address: TAROLU, SUNDHEIM, COVELL TUMMINO & SZABO L.L.P., 1111 LEADER BLDG, 526 SUPERIOR AVENUE, CLEVELAND, OH, 44114-1400, US

(73) Assignee: TRW Automotive Electronics & Components GmbH & Co. KG

(21) Appl. No.: 10/858,949

(22) Filed: Jun. 2, 2004

(30) Foreign Application Priority Data
Mar. 6, 2003 (DE) 103 25 108.1

(51) Int. Cl. G01D 5/34

(52) U.S. Cl. 250/231.13; 250/231.14

(57) ABSTRACT

An optoelectronic angle-of-rotation sensor, in particular for detecting the steering angle in a vehicle steering system, comprises a light source, a photosensitive receiver, and a code disk which can be coupled to a component whose angle of rotation should be detected. The code disk is at least partly transparent for the light of the light source and is provided with an optical coding. The code disk constitutes a light guide and comprising a coupling surface via which the light of the light source enters the code disk, and comprising at least one deflection surface which deflects the light rays to the photosensitive receiver.

### BACKGROUND OF THE INVENTION

Such sensor, particular for detecting the steering angle in a vehicle steering system, can comprise a light source, a photosensitive receiver and a code disk which can be coupled to a component whose angle of rotation should be detected, is at least partly transparent for the light of the light source, and is provided with an optical coding.

Angle-of-rotation sensors are used for instance for determining the angular position of the steering wheel of a vehicle, in particular a motor vehicle. Therefore, such sensor is also referred to as steering-angle sensor. A vehicle equipped with a driving-dynamics control system requires the steering angle apart from other parameters for controlling actuators which act on certain vehicle components such as brakes or vehicle engine.

There are known optoelectronic angle-of-rotation sensors with code disks which are coupled to the rotary movement of a vehicle steering wheel, for instance, wherein the code disk has an optical coding and a light source is provided, whose light rays are deflected in a light-conducting body to the code disk for irradiating the coding. The material of the code disk is at least partly transparent for the radiation of the light source corresponding to the wavelength used. A photosensitive receiver is used for receiving the light rays traversing the code disk and the coding. Preferably, light source, receiver and light-conducting body are arranged on a common carrier. Such optoelectronic angle-of-rotation sensor is described for instance in DE 100 36 769 A1.

The use of a light-conducting body for deflecting the light rays to the coding and the photosensitive receiver results in unfavorable dimensions of the entire sensor at least in terms of height in addition to the actual space requirement of code disk, light source and receiver, as the light rays traverse the code disk in axial direction and a corresponding space must therefore be provided for the light-conducting body on the side of the code disk opposite the receiver.

It is the object underlying the invention to develop an optoelectronic angle-of-rotation sensor to the effect that a reduced space requirement and a simplified assembly of the sensor components is achieved.

### BRIEF DESCRIPTION OF THE INVENTION

In accordance with the invention, this object is solved with a sensor as mentioned above, in which the code disk constitutes a light guide, comprises a coupling surface via which the light of the light source enters the code disk, and comprises at least one deflection surface which deflects the light rays to the photosensitive receiver. By means of this structure of the angle-of-rotation sensor, a light-conducting body as separate component can be omitted, and the dimensions of the sensor in terms of height are reduced, as the peripheral surface of the code disk can be used as coupling surface.

As light source, an LED is used for instance, whose light rays laterally enter the code disk in radial direction via a coupling surface at the same, the coupling surface constituting a lens in one embodiment of the invention, in order to align the divergent light rays substantially parallel for the further passage through the code disk. When such light bundle impinges on a deflection surface in the code disk, at least part of the light bundle is deflected in axial direction, emerges from the code disk, thereby illuminating the code portion present at this point, and subsequently impinges on at least one photosensitive receiver, which is mounted on a printed circuit board.

In preferred embodiments of the invention, phototransistors with different dimensions are used as receivers, wherein smaller phototransistors can be mounted on the side facing the code disk and larger phototransistors can be mounted on the side facing away from the code disk. In this region, the printed circuit board has an opening through which part of the deflected light gets into a phototransistor mounted on the side of the printed circuit board facing away from the code disk. The opening acts as diaphragm for the light rays passing therethrough, whose effect can be influenced via the size of the opening. For evaluating the coded information, the signals of all receivers are used. In this way, an increased accuracy of the sensor can be achieved. Moreover, the printed circuit board also serves as carrier for the light source.

In a preferred embodiment of the invention, an additional diaphragm is provided between code disk and printed circuit board, which is adjustable and replaceable for an optimum adaptation to different receivers.

By using another photosensitive receiver, which is provided at the code disk in a region outside the coding, a reference signal can be obtained for calibrating and reducing a quiescent current. An improvement of the sensor resolution can additionally be achieved by means of a plurality of light sources distributed over the periphery of the code disk.

Advantageous embodiments of the invention can be taken from the sub- claims.

### BRIEF DESCRIPTION OF THE DRAWINGS

The invention will subsequently be explained in detail with reference to an embodiment which is represented in the attached drawings, in which:

FIG. 1 shows an exploded view of an optoelectronic angle-of-rotation sensor in accordance with the invention;

FIG. 2 shows a sectional view of an optoelectronic angle-of-rotation sensor in accordance with the invention as shown in FIG. 1.

### DETAILED DESCRIPTION OF THE INVENTION

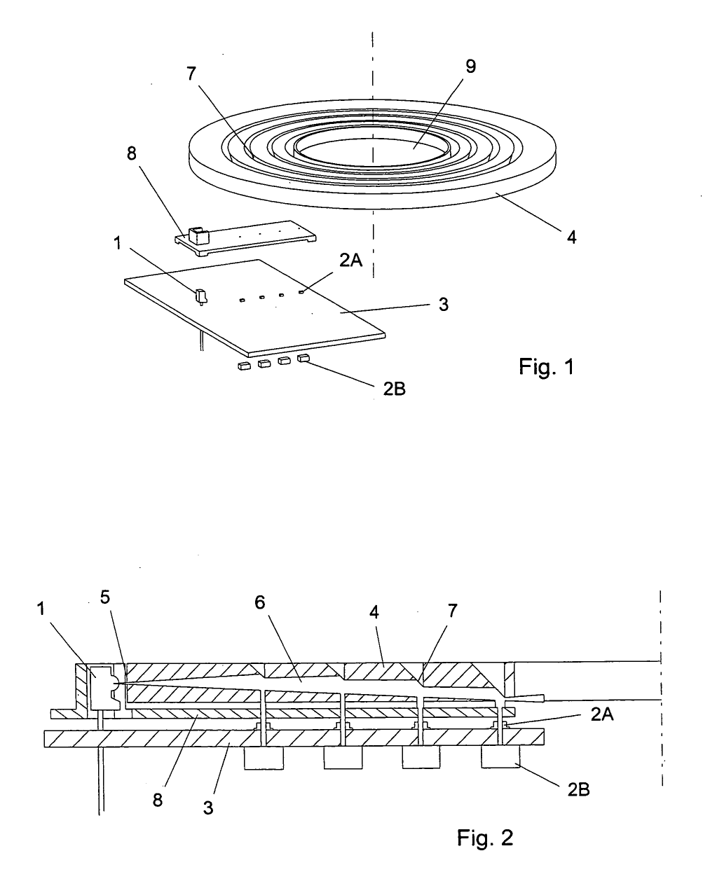

FIG. 1 shows the essential components of a preferred embodiment of an optoelectronic angle-of-rotation sensor in accordance with the invention in a non-assembled condition. A light source 1, preferably an infrared LED, is disposed on a printed circuit board 3. Light rays of the light source 1 laterally radiate in radial direction onto a code disk 4, which is made of a material transparent for the wavelength used, preferably plexiglass. In its middle, the code disk 4 has an opening 9, in which non-rotatably engages for instance the steering spindle of a vehicle. Concentrically arranged deflection surfaces 7 inside the code disk 4 are formed by mirror surfaces arranged at an angle with respect to the radial course of light, at which mirror surfaces a light ray deflection occurs by total reflection.

On the lower surface of the code disk 4 an optical coding is applied, which is formed for instance by a combination of transparent and opaque regions. The coding can be applied by an offset printing method, a laser method or a special paint. The portion of the code disk 4 comprising the coding is located in the vicinity of the printed circuit board 3. In this region, photosensitive receivers 2A, 2B are disposed in radial direction proceeding from the light source 1 for receiving the light rays deflected in the code disk 4. In one embodiment of the invention, the photosensitive receivers 2A, 2B are mounted on the side of the printed circuit board 3 facing the code disk 4 and in another embodiment on the side of the printed circuit board 3 facing away from the code disk 4. At the place of the photosensitive receiver 2B, the printed circuit board 3 is provided with an opening through which passes the light bundle deflected in the code disk 4 and falls into the phototransistor 2B. This opening also serves as diaphragm for regulating the light bundle. An additional adjustable diaphragm 8 is located between the code disk 4 and the printed circuit board 3. Alternatively, the diaphragm 8 can directly be mounted on the printed circuit board 3.

FIG. 2 shows the passage of a light bundle 6 through a code disk 4 in an optoelectronic angle-of-rotation sensor in accordance with the invention as shown in FIG. 1. The light bundle 6 emitted by a light source 1 enters the code disk 4 via a coupling surface 5, the coupling surface 5 acting as lens in a preferred embodiment of the invention and aligning the divergent light beam of the light source 1 substantially parallel. The coupling surface 5 can, however, also be planar, as stray light losses are largely negligeable. Inside the code disk 4, the light bundle 6 extends inwards in radial direction. At certain points, the code disk 4 has deflection surfaces 7, which deflect part of the light bundle 6 in axial direction, so that this part of the light bundle 6 emerges from the code disk 4, illuminates an optical coding applied onto the code disk 4, passes through a diaphragm 8 and impinges on photosensitive receivers 2A, 2B.

The deflected part of the light bundle 6 is each obtained by the arrangement of the deflection surface 7 and the ratio of the specular region of the respective deflection surface 7 irradiated by the light bundle 6 to the total cross-section of the light bundle 6. By means of the concrete design of the deflection surfaces 7 the intensity of the light bundle 6 can thus be divided over the coding to be illuminated in various regions of the code disk 4. After the deflected light has passed the optical coding and a diaphragm 8 used for adjusting and aligning the light beam, it impinges on a photosensitive receiver 2A in accordance with one embodiment of the invention. In another embodiment, the deflected light beam passes through an opening of the printed circuit board and falls into a photosensitive receiver 2B.

1. An optoelectronic angle-of-rotation sensor, in particular for detecting the steering angle in a vehicle steering system, comprising a light source, a photosensitive receiver and a code disk which can be coupled to a component whose angle of rotation should be detected, said code disk being least partly transparent for light of said light source and is provided with an optical coding, said code disk constituting a light guide and comprising a coupling surface via which light of said light source enters said code disk, said code disk further comprising at least one deflection surface which deflects light rays to said photosensitive receiver.

2. The optoelectronic angle-of-rotation sensor as claimed in claim 1, characterized in that said coupling surface is a peripheral surface of said code disk.

3. The optoelectronic angle-of-rotation sensor as claimed in claim 1, characterized in that said coupling surface of said code disk constitutes a lens, in order to achieve a substantially parallel course of light.

4. The optoelectronic angle-of-rotation sensor as claimed in claim 1, characterized in that a diaphragm for adjusting an incidence of light is disposed between said code disk and said photosensitive receiver.

5. The optoelectronic angle-of-rotation sensor as claimed in claim 1, characterized in that a second photosensitive receiver is provided, which receives light uninfluenced by said optical coding.

6. The optoelectronic angle-of-rotation sensor as claimed in claim 1, characterized in that a plurality of light sources are distributed around a periphery of the code disk.

7. The optoelectronic angle-of-rotation sensor as claimed in claim 1, characterized in that a printed circuit board forms a carrier for said light source and said photosensitive receiver.

8. The optoelectronic angle-of-rotation sensor as claimed in claim 8, characterized in that said printed circuit board has an opening for the passage of deflected light at a place of said photosensitive receiver.

9. The optoelectronic angle-of-rotation sensor as claimed in claim 9, characterized in that said opening of said printed circuit board constitutes a diaphragm for deflected light.
